(19) United States
(12) Patent Application Publication
(10) Pub. No.: US 2019/0354866 A1
(43) Pub. Date: Nov. 21, 2019

(54) ARITHMETIC DEVICE AND METHOD FOR CONTROLLING THE SAME

(71) Applicant: TOSHIBA MEMORY CORPORATION, Minato-ku (JP)

(72) Inventors: Kengo Nakata, Tokyo (JP); Daisuke Miyashita, Kawasaki (JP); Jun Deguchi, Kawasaki (JP)

(73) Assignee: TOSHIBA MEMORY CORPORATION, Minato-ku (JP)

(21) Appl. No.: 16/355,767

(22) Filed: Mar. 17, 2019

(30) Foreign Application Priority Data
May 17, 2018 (JP) 2018-095539

(51) Int. Cl. G06N 3/08; G06N 3/063; G06N 3/04

(52) U.S. Cl. CPC G06N 3/084; G06N 3/04; G06N 3/063

(57) ABSTRACT

According to one embodiment, an arithmetic device, includes a first processing layer and a second processing layer, each configured to perform an arithmetic operation on input data and constituting a part of a multi-layer neural network configured to perform corrections by an error backward propagation scheme; a detour path that connects an input and an output of the second processing layer; and an evaluation unit configured to evaluate operation results of the first and the second processing layers.

### CROSS-REFERENCE TO RELATED APPLICATIONS

This application is based upon and claims the benefit of priority from prior Japanese Patent Application No. 2018-095539, filed May 17, 2018; the entire contents of which are incorporated herein by reference.

### FIELD

Embodiments relate to an arithmetic device used for a neural network and a method for controlling the same.

### BACKGROUND

The neural network is a model devised by referring to neurons and synapses of brain, and includes at least two stages of training and classification. In the training stage, features are trained from multiple inputs, and a neural network for classification processing is constructed. In the classification stage, what a new input is classified by using the constructed neural network.

In recent years, technology of the training stage has been greatly developed, and construction of an expressive multi-layer neural network is becoming feasible, by use of, for example, deep learning.

### BRIEF DESCRIPTION OF THE DRAWINGS

FIG. 1 is a block diagram showing a training stage and a classification stage of a classification system according to embodiments.

FIG. 2 is a block diagram showing a hardware configuration of the classification system according to an embodiment.

FIG. 3 is a block diagram showing a classification device of the classification system according to the embodiment.

FIG. 4 is a block diagram showing a training unit of the classification system according to the embodiment.

FIG. 5 is a diagram showing a model of an intermediate layer of the classification system according to the embodiment.

FIG. 6 is a flowchart showing a training operation of the classification system according to the embodiment.

FIG. 7 is a schematic diagram showing an operation of a first processing layer in the training operation according to the embodiment.

FIG. 8 is a schematic diagram showing an operation of a second processing layer in the training operation according to the embodiment.

FIG. 9 is a schematic diagram showing an operation of a third processing layer in the training operation according to the embodiment.

FIG. 10 is a schematic diagram showing an operation of an N-th processing layer in the training operation according to the embodiment.

FIG. 11 is a diagram showing a model of an intermediate layer of a classification system according to a comparative example.

FIG. 12 is a graph showing an advantage of the classification system according to the embodiment, wherein the vertical axis indicates an amount of memory used, and the horizontal axis indicates the number of processing layers.

FIG. 13 is a flowchart showing a training operation of a classification system according to a modification.

### DETAILED DESCRIPTION

In general, according to one embodiment, an arithmetic device, includes a first processing layer and a second processing layer, each configured to perform an arithmetic operation on input data and constituting a part of a multi-layer neural network configured to perform corrections by an error backward propagation scheme; a detour path that connects an input and an output of the second processing layer; an evaluation unit configured to evaluate operation results of the first and the second processing layers; a correction unit configured to correct weight coefficients relating to the first and the second processing layers based on evaluation results of the evaluation unit; and a storage unit configured to store the operation results of the first and the second processing layers, a first weight coefficient relating to the first processing layer, and a second weight coefficient relating to the second processing layer, wherein in a case where the first weight coefficient relating to the first processing layer is corrected, the multi-layer neural network is configured to supply the operation result of the first processing layer via the detour path without performing arithmetic operations of at least one of forward propagation and backward propagation of the second processing layer, the evaluation unit is configured to evaluate the operation result of the first processing layer, the correction unit is configured to correct the first weight coefficient relating to the first processing layer based on an evaluation result of the evaluation unit, and the storage unit is configured to store the operation result of the first processing layer and the weight coefficient relating to the first processing layer.

Hereinafter, embodiments will be described with reference to the drawings. Some embodiments described below are mere examples of a device and method for embodying a technical idea, and the technical idea is not identified by a shape, a configuration, an arrangement, etc., of components. Each function block can be implemented in a form of hardware, software, or a combination thereof. Function blocks are not necessarily separated as in following examples. For example, some functions may be executed by a function block different from the function blocks described as an example. In addition, the function block described as the example may be divided into smaller function subblocks. In the following description, elements having the same function and configuration will be assigned the same reference symbol, and a repetitive description will be given only where necessary.

### <1> Embodiment

<1-1> Configuration

<1-1-1> Overview of Classification System

In the present embodiment, a classification system (arithmetic device) using a multi-layer neural network will be described. The classification system trains a parameter for classifying the contents of classification target data (input data), and classifies the classification target data based on the training result. The classification target data is data to be classified, and is image data, audio data, text data, or the like. Described below as an example is a case where the classification target data is image data, and what is classified is a content of the image (such as a car, a tree, or a human).

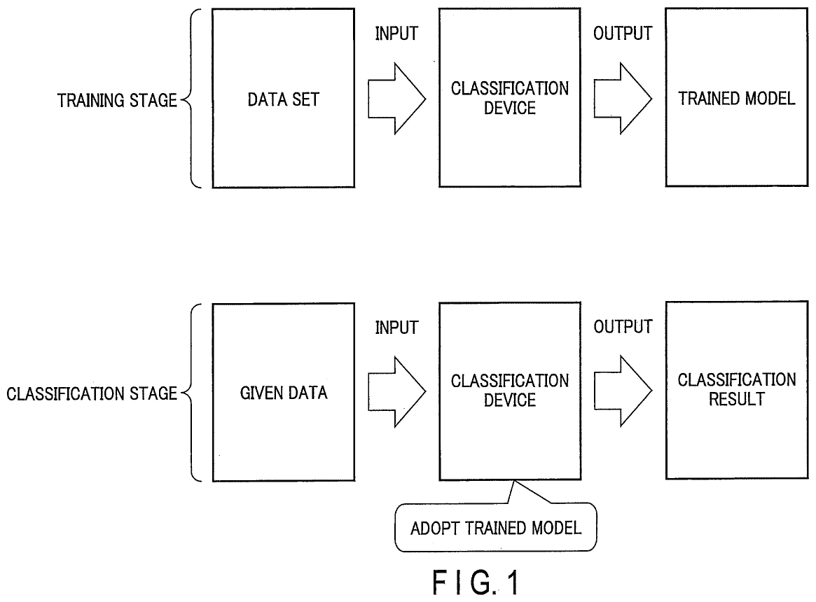

As shown in FIG. 1, in the classification system according to the present embodiment, multiple data items (a data set) for training are input to a classification device in a training stage. The classification device constructs a trained model (neural network) based on the data set.

More specifically, the classification device constructs a trained model for classifying the target data by using a label. The classification device constructs the trained model by using the input data and an evaluation of the label. The evaluation of the label includes a “positive evaluation” indicating that the contents of data match the label, and a “negative evaluation” indicating that the contents of data do not match the label. The positive evaluation or the negative evaluation is associated with a numerical value (truth score, or classification score), such as “0” or “1”, and the numerical value is also referred to as Ground Truth. The “score” is a numerical value, and is a signal itself, which is exchanged in the trained model. The classification device performs an arithmetic operation on the input data, and adjusts a parameter used in the arithmetic operation to bring the classification score, which is the operation result, closer to the truth score. The “classification score” indicates a degree of matching between the input data and the level associated with the input data. The “truth score” indicates an evaluation of the label associated with the input data.

Once a trained model is constructed, what a given input is can be classified by using the trained model as the classification stage.

<1-1-2> Configuration of Classification System

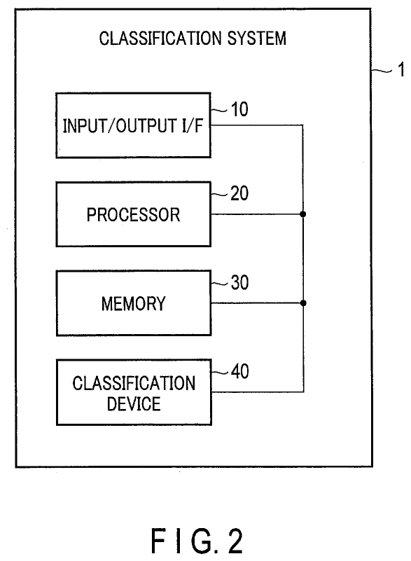

Next, the classification system according to the present embodiment will be described with reference to FIG. 2. FIG. 2 is a block diagram showing a hardware configuration of the classification system.

As shown in FIG. 2, the classification system 1 includes an input/output interface (I/F) 10, a processor (central processing unit (CPU) 20, a memory 30, and a classification device 40.

The input/output interface 10 receives a data set, and outputs a classification result, for example.

The processor 20 controls the entire classification system 1.

The memory 30 includes, for example, a random access memory (RAM), and a read only memory (ROM).

In the training stage, the classification device 40 trains features from, for example, a data set, and constructs a trained model. The constructed trained model is expressed as a weight coefficient used in each arithmetic unit in the classification device 40. Namely, the classification device 40 constructs a trained model which, in a case where input data corresponding to, for example, an image including an image “X” is input, makes an output indicating that the input data is image “X”. The classification device 40 can improve an accuracy of the trained model by receiving many input data items. A method for constructing the trained model of the classification device 40 will be described later.

In the classification stage, the classification device 40 acquires a weight coefficient in the trained model. In a case where the trained model is updated, the classification device 40 acquires a weight coefficient of a new trained model to improve the classification accuracy. The classification device 40 which has acquired the weight coefficient receives input data of classification target. Then, the classification device 40 classifies the received input data in the trained model using the weight coefficient.

Each function of the classification system 1 is realized by causing the processor 20 to read particular software into hardware such as the memory 30, and by reading data from and writing data in the memory 30 under control of the processor 20. The classification device 40 may be hardware, or software executed by the processor 20.

<1-1-3> Configuration of Classification Device

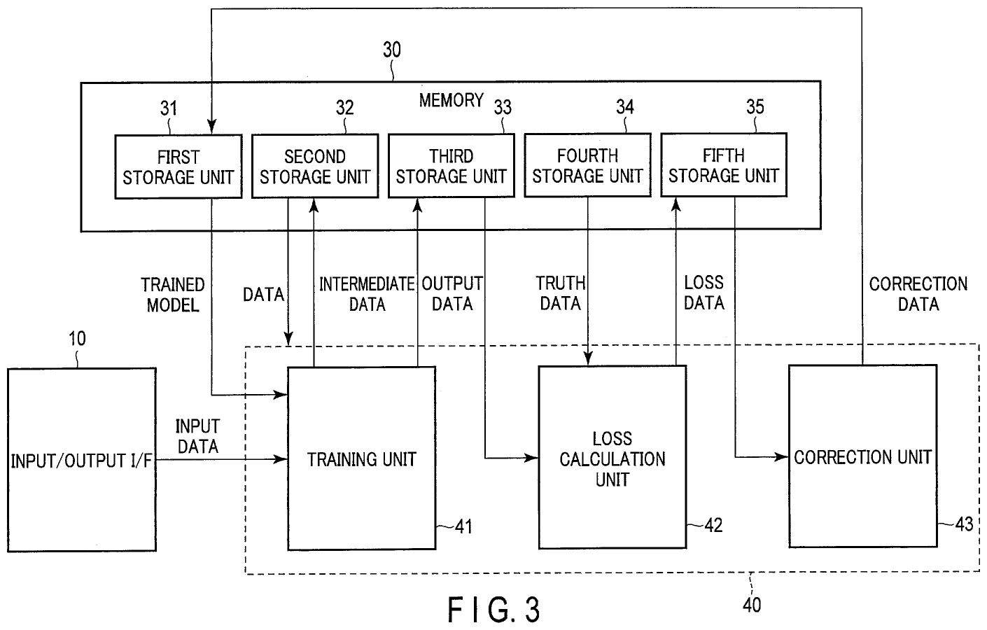

Next, the classification device 40 of the classification system 1 according to the present embodiment will be described with reference to FIG. 3. FIG. 3 is a block diagram showing the classification device 40 of the classification system 1 according to the present embodiment. Here, an operation of the classification device 40 in the training stage will be described.

As shown in FIG. 3, the classification device 40 includes a training unit 41, a loss calculation unit 42, and a correction unit 43. For example, the operation of the classification device 40 is controlled by the processor 20.

A first storage unit 31 provided in the memory 30 stores a trained model (such as a plurality of weight coefficients w). The trained model is read into the training unit 41.

The training unit 41 is configured by the trained model being read from the first storage unit 31. Then, the training unit 41 generates intermediate data based on input data received from the input/output interface 10. The training unit 41 causes a second storage unit 32 provided in the memory 30 to store the intermediate data. Based on the intermediate data, the training unit 41 generates output data (classification score) which is a part of the trained model. The training unit 41 causes a third storage unit 33 provided in the memory 30 to store the output data. The training unit 41 may generate output data which is a part of the trained model based on the intermediate data stored in the second storage unit 32, instead of the input data received from the input/output interface 10.

Based on the output data supplied from the third storage unit 33 and truth data stored in a fourth storage unit 34 provided in the memory 30, the loss calculation unit 42 calculates a loss (error) between the output data (classification score) and the truth data (truth score). Namely, the loss calculation unit 42 functions as an evaluation unit that evaluates an operation result from the training unit 41. The loss calculation unit 42 causes a fifth storage unit 35 provided in the memory 30 to store data indicating a loss (loss data). The truth data is stored in, for example, the fourth storage unit 34.

The correction unit 43 generates correction data for correcting (updating) an operation parameter of the training unit 41 to bring the output data (classification score) closer to the truth data (truth score), based on the loss data supplied from the fifth storage unit 35, and outputs the correction data. The correction unit 43 is configured to correct the data of the first storage unit 31 by using the correction data. The trained model is thereby corrected. For example, a correction using a gradient method can be applied to the correction by the correction unit 43.

<1-1-4> Configuration of Training Unit

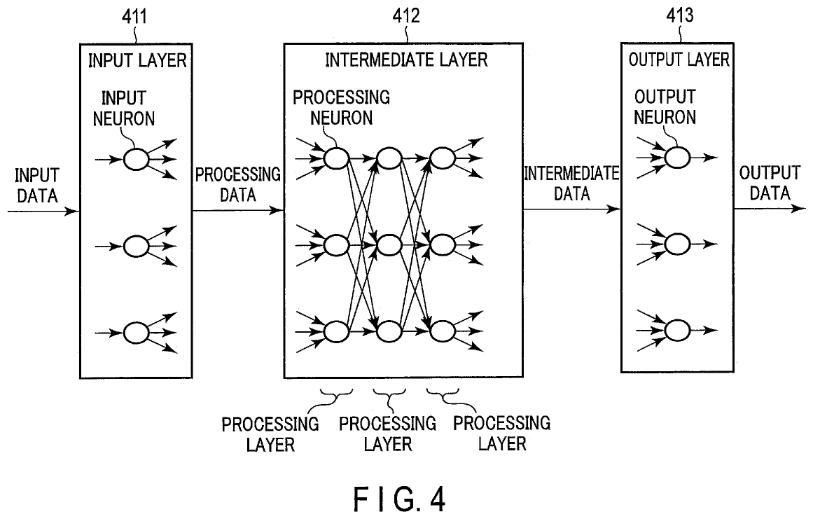

Next, the training unit of the classification system according to the present embodiment will be described with reference to FIG. 4. FIG. 4 is a block diagram showing the training unit of the classification system according to the present embodiment. As described above, the training unit is configured based on the trained model stored in the first storage unit 31. Described below is the case where a multi-layer neural network which includes multiple (three or more) processing layers is adopted. Hereinafter, the trained model is synonymous with the multi-layer neural network.

As shown in FIG. 4, the training unit 41 includes an input layer 411, an intermediate layer 412, and an output layer 413.

In the input layer 411, input neurons are arranged in parallel. The input neuron acquires input data as processing data which can be processed in the intermediate layer 412, and outputs (distributes) it to processing neurons included in the intermediate layer 412. The neuron of the present embodiment is a model modeled on the brain neuron. The neuron may be referred to as a node.

The intermediate layer 412 includes multiple (for example, three or more) processing layers, in each of which processing neurons are arranged in parallel. Each processing neuron performs an arithmetic operation on processing data by using a weight coefficient, and outputs an operation result (operation data) to a neuron or neurons of the subsequent layer.

In the output layer 413, output neurons, the number of which is the same as the number of labels, are arranged in parallel. The labels are each associated with classification target data. The output layer 413 outputs a classification score for each output neuron, based on intermediate data received from the intermediate layer 412. Namely, the training unit 41 outputs a classification score for each label. For example, in a case where the training unit 41 classifies three images of “car”, “tree”, and “human”, the output layer 413 has three output neurons arranged in correspondence to the three labels, “car”, “tree”, and “human”. The output neurons output a classification score corresponding to the label of “car”, a classification score corresponding to the label of “tree”, and a classification score corresponding to the label of “human”.

<1-1-5> Configuration of Intermediate Layer

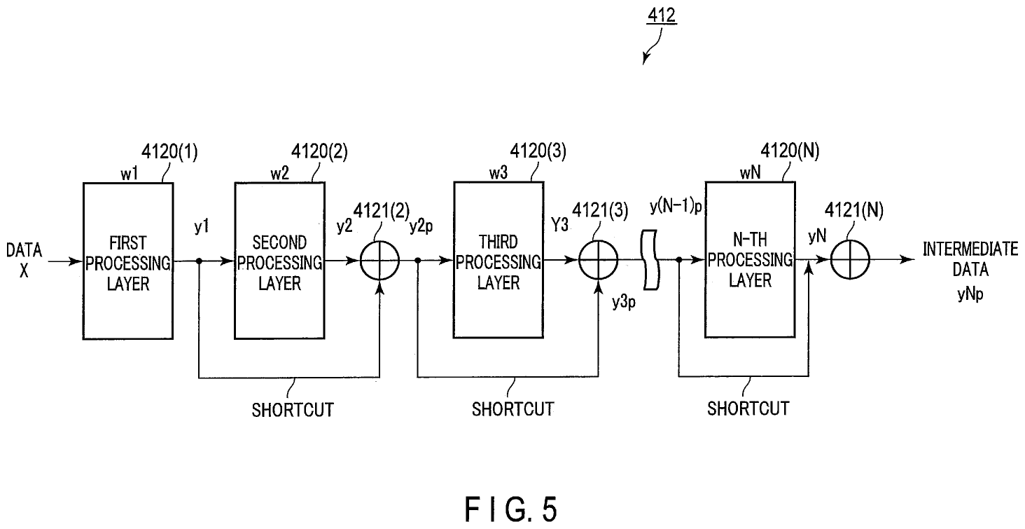

Next, the intermediate layer of the classification system according to the present embodiment will be described with reference to FIG. 5. FIG. 5 is a diagram showing a model of the intermediate layer of the classification system according to the present embodiment. The configuration of the intermediate layer is a model called a residual network (or ResNet). The residual network is different from a normal neural network in that the number of processing layers (also referred to as the number of layers) is larger than the number of processing layers in the model of a normal neural network, and in that a detour path (a shortcut and an adder) that connects the input and output of each processing layer is provided. The model of the intermediate layer described below is an example.

As shown in FIG. 5, the intermediate layer 412 includes a plurality of processing layers (N (N is an integer equal to or larger than 4) layers in the example of FIG. 5) 4120. At the outputs of processing layers 4120(2)-(N), adders 4121(2)-(N) are provided, respectively. In addition, shortcuts for causing data input to processing layers 4120(2)-(N) to bypass the processing layers 4120(2)-(N) to avoid an arithmetic operation are provided, and the adders 4121(2)-(N) add up the outputs of processing layers 4120(2)-(N) and outputs of processing layers 4120(1)-(N−1) supplied via the shortcuts. The positions of the shortcuts, the number of the shortcuts, etc., can be changed as appropriate.

Each processing layer 4120 includes a plurality of processing neurons (not shown) arranged in parallel. The processing neuron performs an arithmetic operation on input data based on the weight coefficient w set for each processing layer 4120 to generate data y (also referred to as an activation) which is the output data of each neuron.

Each shortcut supplies input data of a processing layer 4120 to the adder in the subsequent stage of the processing layer 4120 by causing the input data to bypass the processing layer 4120.

The adder 4121 adds up the data supplied via the shortcut and the data supplied from the processing layer 4120 in the preceding stage.

In the intermediate layer 412, the processing layer 4120 and the adder 4121 are arranged in order from the processing layer 4120 to which data is input to the processing layer 4120 from which data is output. For a processing layer 4120, the processing layer 4120 or adder 4121 on the data input side is referred to as being in the preceding stage, and the processing layer 4120 or adder 4121 on the data output side is referred to as being in the subsequent stage.

Hereinafter, a specific example of the intermediate layer 412 will be described.

A first processing layer 4120(1) arranged on the input side of the intermediate layer 412 includes a plurality of processing neurons (not shown) arranged in parallel. The processing neurons are connected to respective neurons of the input layer 411. The processing neurons each perform an arithmetic operation on input data x based on the weight coefficient w1 set for the first processing layer 4120(1), and generate data y1. Data y1 is transmitted to a second processing layer 4120(2), and to adder 4121(2) via a shortcut.

A plurality of neurons of the second processing layer 4120(2) are connected to the respective neurons of the first processing layer 4120(1). The processing neurons each perform an arithmetic operation on data y1 based on the weight coefficient w2 set for the second processing layer 4120(2), and generate data y2.

Adder 4121(2) adds up data y2 from the second processing layer 4120(2) and data y1 from the first processing layer 4120(1), and generates data y2p. Data y2p is transmitted to a third processing layer 4120(3), and to adder 4121(3).

A plurality of neurons of the third processing layer 4120(3) are each connected to adder 4121(2). The processing neurons each perform an arithmetic operation on data y2p based on the weight coefficient w3 set for the third processing layer 4120(3), and generate data y3.

Adder 4121(3) adds up data y3 from the third processing layer 4120(3) and data y2p from adder 4121(2), and generates data y3p. Data y3p is transmitted to a fourth processing layer 4120(4) (not shown), and to adder 4121(4) (not shown).

A plurality of processing neurons of the N-th processing layer 4120(N) are each connected to adder 4121(N−1) (not shown). The processing neurons each perform an arithmetic operation on data y(N−1)p based on the weight coefficient wN set for the N-th processing layer 4120(N), and generate data yN.

Adder 4121(N) adds up data yN from the N-th processing layer 4120(N) and data y(N−1)p from adder 4121(N−1), and generates data yNp. Adder 4121(N) outputs the generated data yNp as intermediate data.

<1-2> Operation

<1-2-1> Overview of Operation of Training Stage

An overview of the operation of the Training stage (Training operation) of the classification system according to the present embodiment will be described.

In the training operation, the training unit 41 generates output data for each processing layer 4120. Then, the loss calculation unit 42 calculates a loss between the output data and the truth data for each processing layer 4120. Furthermore, the correction unit 43 generates correction data for correcting the operation parameter of each processing layer 4120 to bring the output data closer to the truth data, based on the loss data. Accordingly, the correction unit 43 generates correction data for all the processing layers 4120.

<1-2-2> Details of Operation of Training Stage

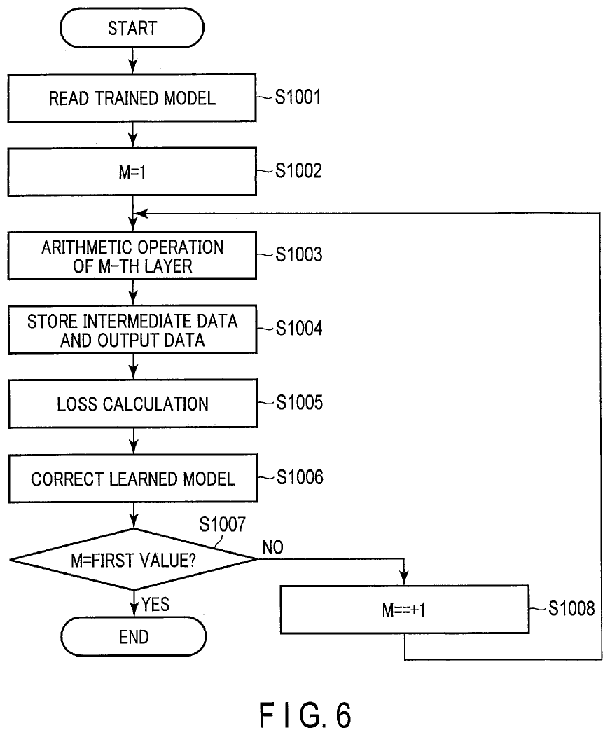

Next, the training operation of the classification system according to the present embodiment will be described in detail with reference to FIG. 6. FIG. 6 is a flowchart showing the training operation of the classification system according to the present embodiment.

[S1001]

The training unit 41 reads the trained model stored in the first storage unit 31. This trained model is set in, for example, the processor 20.

[S1002]

As mentioned above, the training unit 41 generates output data for each M-th processing layer 4120 (M) (M is an integer equal to or larger than 1). In a case where performing the training operation, the training unit 41 sets the variable M to 1 (M=1) to select the first processing layer 4120(1).

[S1003]

The training unit 41 generates intermediate data and output data of the M-th processing layer 4120(M) by using input data or intermediate data (data from the (M−1)-th processing layer in the preceding stage, which was acquired by performing the arithmetic operations before correction of the trained model) stored in the second storage unit 32. In this processing, the training unit skips the operations by the other processing layers via shortcuts.

[S1004]

The training unit 41 causes the memory 30 to store the intermediate data and output data generated in S1003. Specifically, the training unit 41 stores the intermediate data generated by the M-th processing layer 4120(M) in the second storage unit 32. The training unit 41 generates output data based on the intermediate data generated by the M-th processing layer 4120(M). Then, output data relating to the M-th processing layer 4120(M) is stored in the third storage unit 33. Namely, the second storage unit 32 needs to store at least the intermediate data of the M-th processing layer 4120(M) and the data input to the M-th processing layer 4120(M), but does not need to store intermediate data of all the processing layers. Similarly, the third storage unit 33 needs to store at least the output data of the M-th processing layer 4120(M), but does not need to store output data of all the processing layers.

The intermediate data and output data may be written in the unused area of the memory 30, and may be overwritten in the area in which invalid data, which is not used in the subsequent stage (S1003), is stored. From the viewpoint of reducing the used amount of the memory, it is preferable to overwrite disused data, if possible.

[S1005]

The loss calculation unit 42 calculates a loss between the output data based on the M-th processing layer 4120(M) and the truth data.

[S1006]

Based on the loss data relating to the calculated loss, the correction unit 43 generates correction data for correcting the operation parameter (weight coefficient wM) of the M-th processing layer 4120(M) to bring the output data closer to the truth data. The trained model stored in the first storage unit 31 is corrected by using this correction data.

[S1007]

The processor 20 determines whether the variant M has reached the first value (for example, N in FIG. 5).

[S1008]

In a case where determining that M has not reached the first value (NO in S1007), the processor 20 increments M by one, and repeats the operations from S1003 onward.

In a case where determining that variable M has reached the first value (YES in S1007), the processor 20 ends the circuit training operation relating to all the processing layers 4120 of the intermediate layer 412. Namely, the classification device 40 sequentially corrects the weight coefficients from the processing layer 4120 close to the input to the processing layer 4120 close to the output.

By repeating the above S1001 to S1008 a desired number of times, a trained model is constructed.

<1-2-3> Specific Example of Training Operation

As described above, the classification device 40 sequentially performs arithmetic operations and corrections from the first processing layer to the N-th processing layer in the training operation.

To facilitate understanding of the training operation, a specific example will be described. Here, the operations of the first processing layer 4120(1), second processing layer 4120(2), third processing layer 4120(3), and N-th processing layer 4120(N) of the first to N-th processing layers 4120(1)-(N) will be described.

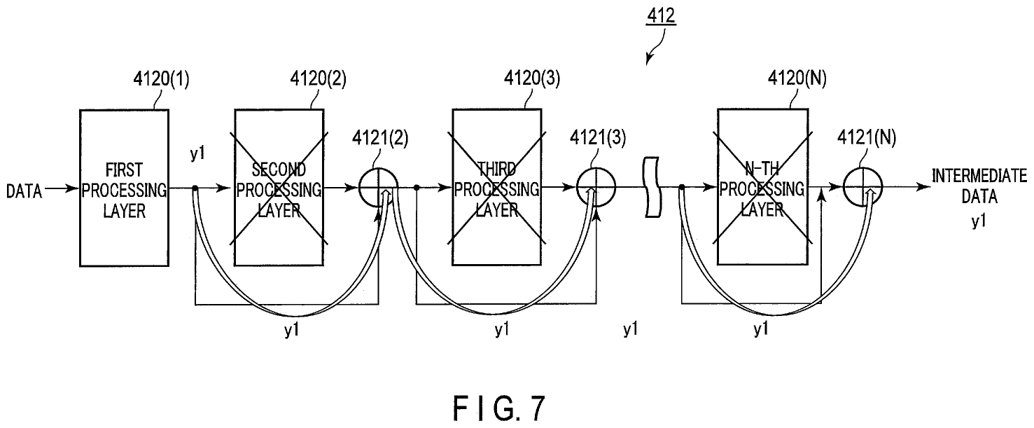

First, the operation of the intermediate layer 412 in the training operation of the first processing layer 4120(1) will be described with reference to FIG. 7. FIG. 7 is a schematic diagram showing an operation of the first processing layer 4120(1) in the training operation.

As shown in FIG. 7, in a case where input data is input to the input layer 411, the intermediate layer 412 first causes only the first processing layer 4120(1) to perform an arithmetic operation. Without causing the other processing layers 4120 to perform an arithmetic operation (by skipping arithmetic operations by the other processing layers 4120), the intermediate layer 412 outputs, via shortcuts, data y1 generated by the first processing layer 4120(1) as intermediate data. Then, the intermediate layer 412 stores data y1 in the second storage unit 32. The output layer 413 generates output data based on data y1.

The intermediate data and output data relating to the first processing layer 4120(1) is thereby stored in the memory 30. Then, correction data relating to the first processing layer 4120(1) is generated by the loss calculation unit 42 and the correction unit 43. Consequently, the weight coefficient w1 relating to the first processing layer 4120(1) is corrected based on the correction data.

After the weight coefficient w1 relating to the first processing layer 4120(1) is corrected, an arithmetic operation is performed by using the second processing layer 4120(2) in the subsequent stage.

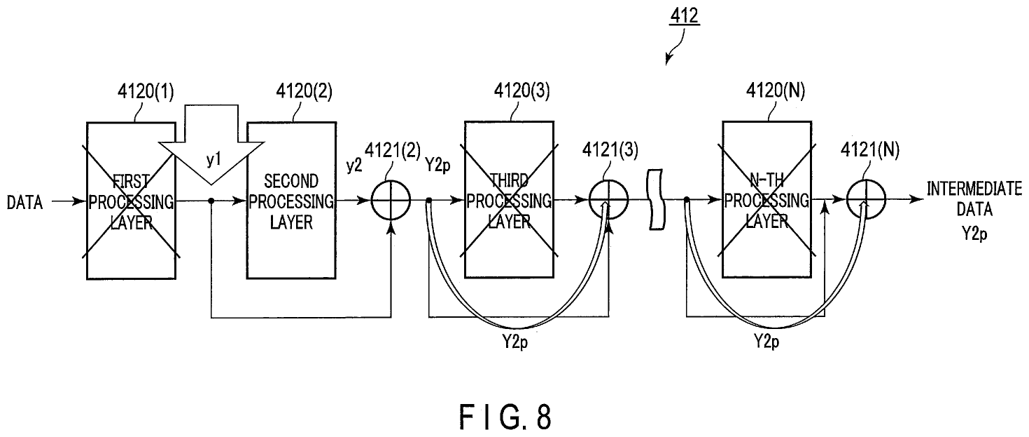

The operation of the intermediate layer 412 in the training operation of the second processing layer 4120(2) will be described with reference to FIG. 8. FIG. 8 is a schematic diagram showing an operation of the second processing layer 4120(2) in the training operation.

As shown in FIG. 8, the intermediate layer 412 causes only the second processing layer 4120(2) to perform an arithmetic operation, and outputs data. The second processing layer 4120(2) generates data y2 based on the operation result (data y1) of the first processing layer 4120(1) stored in the second storage unit 32. The intermediate layer 412 generates data y2p based on data y1 and data y2 by using adder 4121(2).Without causing the other processing layers 4120 to perform an arithmetic operation (by skipping arithmetic operations by the other processing layers 4120), the intermediate layer 412 outputs, via shortcuts, data y2p as intermediate data. Then, the intermediate layer 412 stores data y2p in the second storage unit 32. The output layer 413 generates output data based on data y2p.

The intermediate data and output data relating to the second processing layer 4120(2) is thereby stored in the memory 30. Then, correction data relating to the second processing layer 4120(2) is generated by the loss calculation unit 42 and the correction unit 43. The weight coefficient w2 relating to the second processing layer 4120(2) is corrected based on the correction data.

After the weight coefficient w2 relating to the second processing layer 4120(2) is corrected, an arithmetic operation is performed by using the third processing layer 4120(3) in the subsequent stage.

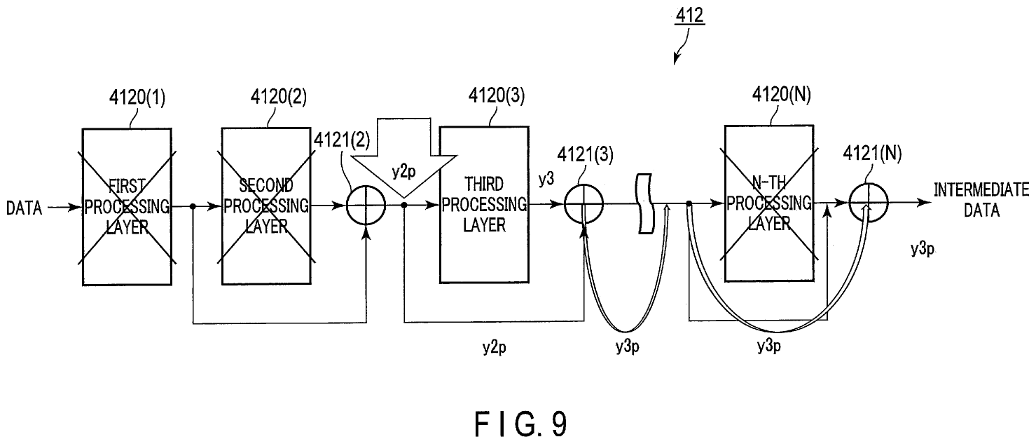

The operation of the intermediate layer 412 in the training operation of the third processing layer 4120(3) will be described with reference to FIG. 9. FIG. 9 is a schematic diagram showing an operation of the third processing layer 4120(3) in the training operation.

As shown in FIG. 9, the intermediate layer 412 causes only the third processing layer 4120(3) to perform an arithmetic operation, and outputs data. The third processing layer 4120(3) generates data y3 based on the operation result (data y2p) of the second processing layer 4120(2) stored in the second storage unit 32. The intermediate layer 412 generates data y3p based on data y2p and data y3 by using adder 4121(3). Without causing the other processing layers 4120 to perform an arithmetic operation (by skipping arithmetic operations by the other processing layers 4120), the intermediate layer 412 outputs, via shortcuts, data y3p as intermediate data. Then, the intermediate layer 412 stores data y3p in the second storage unit 32. The output layer 413 generates output data based on data y3p.

The intermediate data and output data relating to the third processing layer 4120(3) is thereby stored in the memory 30. Then, correction data relating to the third processing layer 4120(3) is generated by the loss calculation unit 42 and the correction unit 43. The weight coefficient w3 relating to the third processing layer 4120(3) is corrected based on the correction data.

After the weight coefficient w3 relating to the third processing layer 4120(3) is corrected, an arithmetic operation is performed by using the fourth processing layer 4120(4) in the subsequent stage (not shown).

The operations of the fourth to (N−1)-th processing layers (4)-(N−1) are similar to the operation relating to the third processing layer 4120(3).

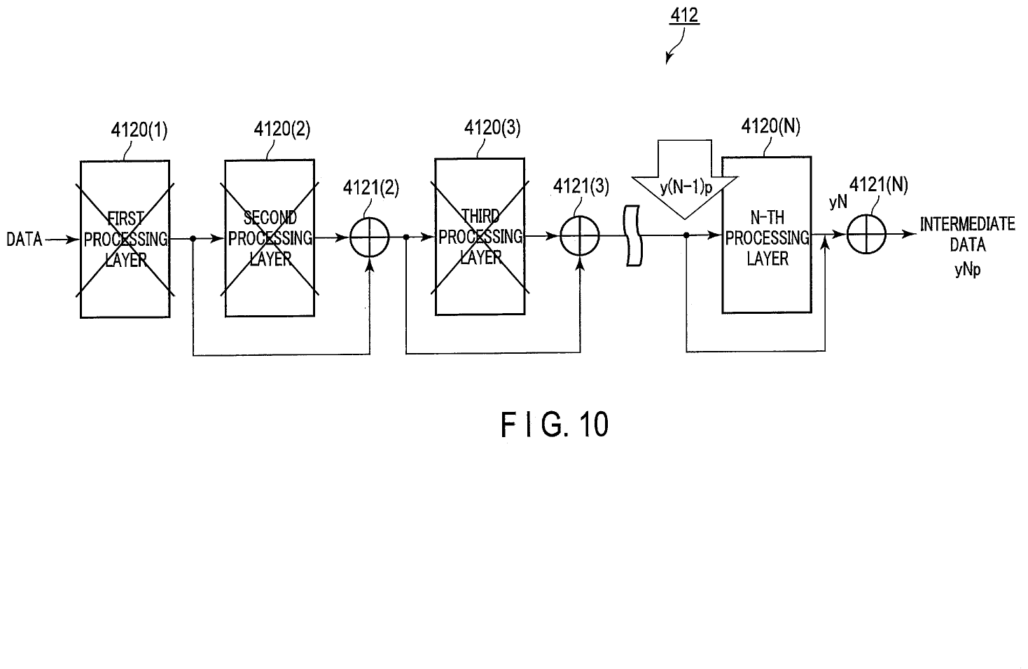

The operation of the intermediate layer 412 in the training operation of the N-th processing layer 4120(N) will be described with reference to FIG. 10. FIG. 10 is a schematic diagram showing an operation of the N-th processing layer 4120(N) in the training operation.

As shown in FIG. 10, the intermediate layer 412 causes only the N-th processing layer 4120(N) to perform an arithmetic operation, and outputs data. The N-th processing layer 4120(N) generates data yN based on the operation result (data y(N−1)p) of the (N−1)-th processing layer 4120(N−1) stored in the second storage unit 32. The intermediate layer 412 generates data yNp based on data y(N−1)p and data yN by using adder 4121(N). Then, the intermediate layer 412 outputs data yNp as intermediate data. After that, the intermediate layer 412 stores data yNp in the second storage unit 32. The output layer 413 generates output data based on data yNp.

The intermediate data and output data relating to the N-th processing layer 4120(N) is thereby stored in the memory 30. Then, correction data relating to the N-th processing layer 4120(N) is generated by the loss calculation unit 42 and the correction unit 43. The weight coefficient wN relating to the N-th processing layer 4120(N) is corrected based on the correction data.

<1-3> Advantage

According to the above-described embodiment, the classification system causes one operation result of a processing layer in the intermediate layer to skip an arithmetic operation of a processing layer via a shortcut at least once. Then, the classification system performs an arithmetic operation to acquire a loss, based on the operation result acquired by skipping. Then, the classification system corrects the weight coefficient of the processing layer based on the acquired loss.

To explain the advantage of the present embodiment, a comparative example will be described below.

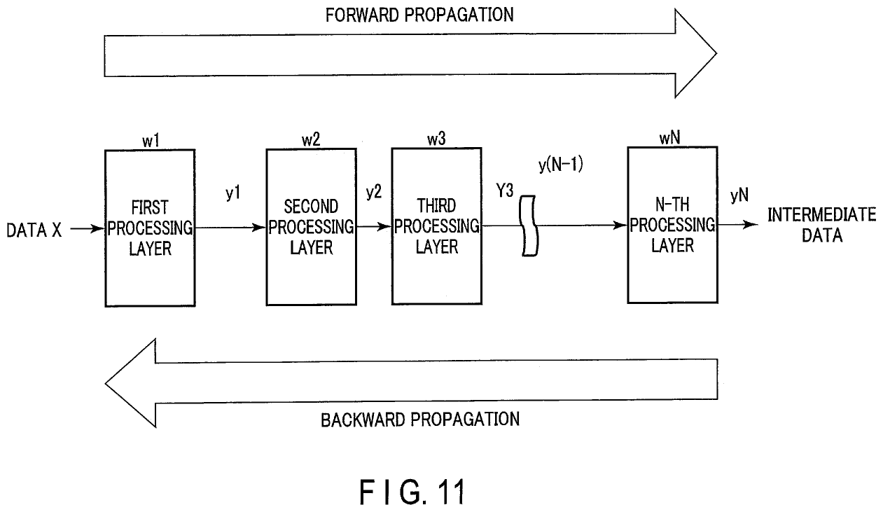

As one model adopted as the intermediate layer, a multi-layer network model having no shortcut is conceivable (see FIG. 11). In the training operation using such a model, arithmetic operations are sequentially performed from the processing layer close to the data input side to the processing layer close to the data output side. This operation may be referred to as forward propagation. Based on the intermediate data calculated by the forward propagation, correction data is generated, and correction is sequentially performed from the processing layer close to the data output side to the processing layer close to the data input side in the intermediate layer. This operation may be referred to as an error backward propagation scheme (also simply referred to as backward propagation). In a case where there are multiple processing layers, there is a problem that the closer the processing layer is to the data input side, the smaller the value resulting from the gradient convergence, until the gradient vanishes. In a case where the gradient vanishes, there arises a problem that update is not performed, and training does not advance.

As described above, by providing a shortcut to skip an arithmetic operation of a processing layer 4120, the above problem can be solved.

It is also conceivable to correct the weight coefficient of a processing layer by using backward propagation in a model with a shortcut to skip an arithmetic operation of a processing layer 4120. In a case where a correction is performed by backward propagation, the arithmetic operations of all the processing layers need to be performed by forward propagation. In this case, the operation results of all the processing layers need to be stored in the memory 30. Therefore, there arises a problem that the capacity required for the memory 30 increases as the number of processing layers increases.

However, in the present embodiment, a method of performing an arithmetic operation by one processing layer and performing a correction of the processing layer is adopted as the training operation. As a result, the memory 30 only needs to store at least the operation result of the processing layer on which a correction is performed, and an operation result input to the processing layer on which a correction is performed.

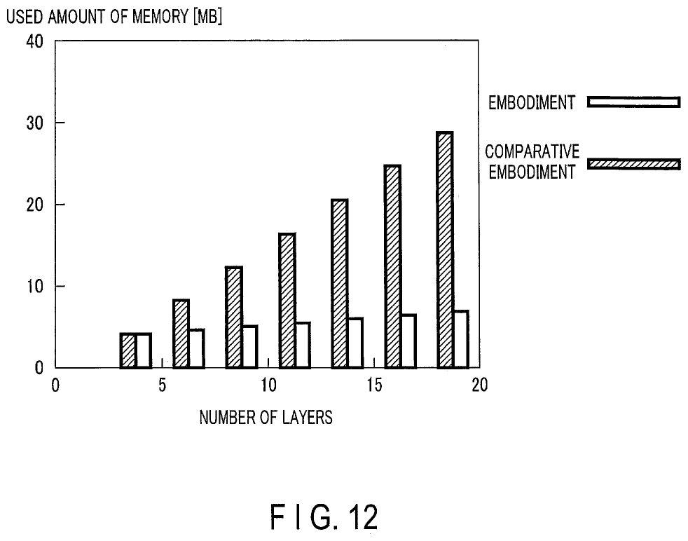

Therefore, as shown in FIG. 12, even when the number of processing layers increases, the used amount of the memory can be inhibited from increasing. The horizontal axis of FIG. 12 indicates the number of processing layers, and the vertical axis indicates the used amount of the memory. FIG. 12 is one specific example, and the relationship between the number of processing layers and the used amount of the memory is not limited to this.

As described above, the above-described embodiment can provide a classification system that can save the used amount of the memory while inhibiting the training speed from dropping.

### <2> Modification

Next, a modification of the embodiment will be described.

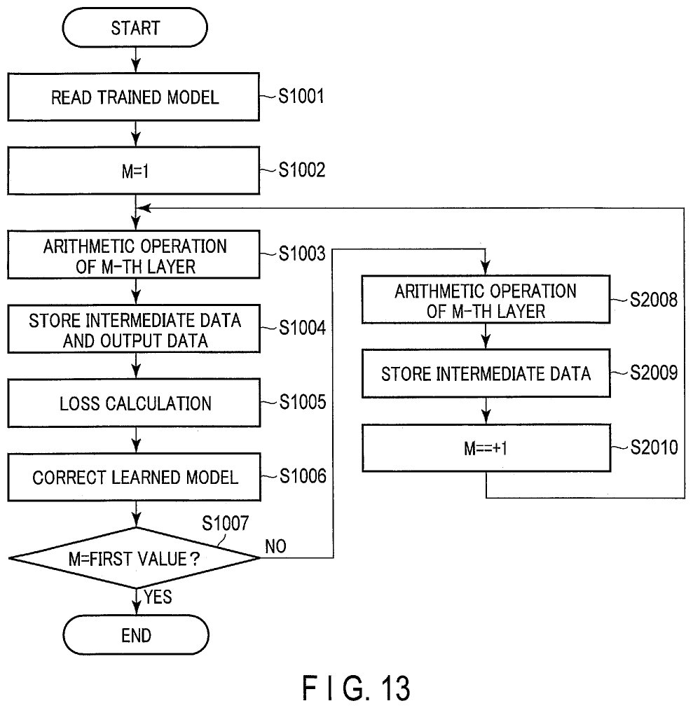

In the modification, details of another training operation of the classification system will be described with reference to FIG. 13. Descriptions of the same operations as those described with reference to FIG. 6 will be omitted.

[S1001]-[S1007]

S1001-S1007 in FIG. 13 are basically the same as S1001-S1007 in FIG. 6.

[S2008]

In a case where the processor 20 determines that the variable M has not reached the first value (NO in S1007), the training unit 41 generates intermediate data of the M-th processing layer 4120(M) by using input data or intermediate data (data from the (M−1)-th processing layer 4120(M−1) in the preceding stage acquired after correction of the trained model) stored in the second storage unit 32. In this processing, the training unit skips the processes by the other processing layers via shortcuts.

[S2009]

The training unit 41 causes the memory 30 to store the intermediate data generated in S2008. Specifically, the training unit 41 stores, in the second storage unit 32, the intermediate data generated by the M-th processing layer 4120(M) after correction of the trained model.

Consequently, the second storage unit 32 stores data of the M-th processing layer acquired after correction of the trained model.

[S2010]

The processor 20 increments the variable M by one, and repeats the operations from S1003 onward.

As described above, by adding the processes of S2008 and S2009 to the operation described with reference to FIG. 6, intermediate data of the M-th processing layer 4120(M) can be generated in S1003 by using data of the (M−1)-th processing layer 4120(M−1) in the preceding stage acquired by performing the arithmetic by performing the arithmetic operations after correction of the trained model. Accordingly, the weight coefficient of the M-th processing layer 4120(M) can be corrected with a higher degree of accuracy.

In the above-described embodiment, the operations of the processing layers other than the processing layer on which a correction is performed are described as being able to be skipped in the training operation; however, the embodiment can be applied to the case where they cannot be skipped. For example, even when there is a processing layer that cannot be skipped, i.e., a processing layer without a shortcut, because of the requirement of the model, the present embodiment may be applied.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An arithmetic device, comprising:
a first processing layer and a second processing layer, each configured to perform an arithmetic operation on input data and constituting a part of a multi-layer neural network configured to perform corrections by an error backward propagation scheme;
a detour path that connects an input and an output of the second processing layer;
an evaluation unit configured to evaluate operation results of the first and the second processing layers;
a correction unit configured to correct weight coefficients relating to the first and the second processing layers based on evaluation results of the evaluation unit; and
a storage unit configured to store the operation results of the first and the second processing layers, a first weight coefficient relating to the first processing layer, and a second weight coefficient relating to the second processing layer, wherein
in a case where the first weight coefficient relating to the first processing layer is corrected, the multi-layer neural network is configured to supply a first operation result of the first processing layer via the detour path without performing arithmetic operations of at least one of forward propagation and backward propagation of the second processing layer, the evaluation unit is configured to evaluate the first operation result of the first processing layer, the correction unit is configured to correct the first weight coefficient relating to the first processing layer based on an evaluation result of the evaluation unit, and the storage unit is configured to store the first operation result of the first processing layer and the first weight coefficient relating to the first processing layer.

2. The arithmetic device according to claim 1, wherein
the first processing layer is configured to perform an arithmetic operation on the input data, and the second processing layer is configured to perform an arithmetic operation on output data of the first processing layer, and
in a case where the weight coefficients relating to the first and the second processing layers are corrected, the first weight coefficient relating to the first processing layer and the second weight coefficient relating to the second processing layer are corrected in order of appearance.

3. The arithmetic device according to claim 1, wherein
in a case where the second weight coefficient relating to the second processing layer is corrected, an operation result of the first weight coefficient relating to the first processing layer before correction is used.

4. The arithmetic device according to claim 1, wherein
in a case where the second weight coefficient relating to the second processing layer is corrected, an operation result of the first weight coefficient relating to the first processing layer after correction is used.

5. The arithmetic device according to claim 1, wherein the multi-layer neural network is configured to classify a content of the input data by using the first weight coefficient relating to the first processing layer and the second weight coefficient relating to the second processing layer stored in the storage unit.

6. The arithmetic device according to claim 1, wherein the evaluation unit is configured to evaluate the operation results of the first and the second processing layers by using truth data stored in the storage unit.

7. The arithmetic device according to claim 1, further comprising:
a third processing layer configured to perform an arithmetic operation on the input data and constituting a part of the multi-layer neural network; and
a second detour path that connects an input and an output of the third processing layer, wherein
the output of the second processing layer is connected to the input of the third processing layer,
the evaluation unit is configured to evaluate operation results of the first to the third processing layers,
the correction unit is configured to correct weight coefficients relating to the first to the third processing layers based on an evaluation result of the evaluation unit, and
the storage unit is further configured to store the operation results of the first to the third processing layers, the first weight coefficient relating to the first processing layer, the second weight coefficient relating to the second processing layer, and a third weight coefficient relating to the third processing layer, and wherein
in a case where the first weight coefficient relating to the first processing layer is corrected, the multi-layer neural network is configured to supply the operation result of the first processing layer via the second detour path without performing arithmetic operations of at least one of forward propagation and backward propagation of the second and the third processing layers, the evaluation unit is configured to evaluate the operation result of the first processing layer, the correction unit is configured to correct the first weight coefficient relating to the first processing layer based on the evaluation result of the evaluation unit, and the storage unit is configured to store the operation result of the first processing layer and the weight coefficient relating to the first processing layer.

8. The arithmetic device according to claim 7, wherein
the first processing layer is configured to perform an arithmetic operation on the input data, the second processing layer is configured to perform an arithmetic operation on output data of the first processing layer, and the third processing layer is configured to perform an arithmetic operation on output data of the second processing layer, and
in a case where the weight coefficients relating to the first, the second, and the third processing layers are corrected, the first weight coefficient relating to the first processing layer, the second weight coefficient relating to the second processing layer, and the third weight coefficient relating to the third processing layer are corrected in order of appearance.

9. The arithmetic device according to claim 7, wherein
in a case where the third weight coefficient relating to the third processing layer is corrected, an operation result of the second weight coefficient relating to the second processing layer before correction is used.

10. The arithmetic device according to claim 7, wherein
in a case where the third weight coefficient relating to the third processing layer is corrected, an operation result of the second weight coefficient relating to the second processing layer after correction is used.

11. A method for controlling an arithmetic device comprising:
a first processing layer and the second processing layer, each configured to perform an arithmetic operation on input data and constituting a part of a multi-layer neural network configured to perform corrections by an error backward propagation scheme;
a detour path that connects an input and an output of the second processing layer;
an evaluation unit configured to evaluate operation results of the first and the second processing layers;
a correction unit configured to correct weight coefficients relating to the first and the second processing layers based on evaluation results of the evaluation unit; and
a storage unit configured to store the operation results of the first and the second processing layers, a first weight coefficient relating to the first processing layer, and a second weight coefficient relating to the second processing layer,
the method comprising: in a case where correcting the first weight coefficient relating to the first processing layer, supplying, by the multi-layer neural network, a first operation result of the first processing layer via the detour path without performing arithmetic operations of at least one of forward propagation and backward propagation of the second processing layer; evaluating, by the evaluation unit, the first operation result of the first processing layer; correcting, by the correction unit, the first weight coefficient relating to the first processing layer based on an evaluation result of the evaluation unit; and storing, by the storage unit, the first operation result of the first processing layer and the first weight coefficient relating to the first processing layer.

12. The method according to claim 11, wherein
the first processing layer is configured to perform an arithmetic operation on the input data, and the second processing layer is configured to perform an arithmetic operation on output data of the first processing layer, and
in a case where the weight coefficients relating to the first and the second processing layers are corrected, the first weight coefficient relating to the first processing layer and the second weight coefficient relating to the second processing layer are corrected in order of appearance.

13. The method according to claim 11, wherein
in a case where the second weight coefficient relating to the second processing layer is corrected, an operation result of the first weight coefficient relating to the first processing layer before correction is used.

14. The method according to claim 11, wherein
in a case where the second weight coefficient relating to the second processing layer is corrected, an operation result of the first weight coefficient relating to the first processing layer after correction is used.

15. The method according to claim 11, wherein the multi-layer neural network is configured to classify a content of the input data by using the first weight coefficient relating to the first processing layer and the second weight coefficient relating to the second processing layer stored in the storage unit.

16. The method according to claim 11, wherein the evaluation unit is configured to evaluate the operation results of the first and the second processing layers by using truth data stored in the storage unit.

17. The method according to claim 11, further comprising:
a third processing layer configured to perform an arithmetic operation on the input data and constituting a part of the multi-layer neural network; and
a second detour path that connects an input and an output of the third processing layer, wherein
the output of the second processing layer is connected to the input of the third processing layer,
the evaluation unit is configured to evaluate operation results of the first to the third processing layers, and
the correction unit is configured to correct weight coefficients relating to the first to the third processing layers based on an evaluation result of the evaluation unit, and
the storage unit further is configured to store the operation results of the first to the third processing layers, the first weight coefficient relating to the first processing layer, the second weight coefficient relating to the second processing layer, and a third weight coefficient relating to the third processing layer, and wherein
in a case where the first weight coefficient relating to the first processing layer is corrected, the multi-layer neural network is configured to supply the operation result of the first processing layer via the second detour path without performing arithmetic operations of at least one of forward propagation and backward propagation of the second and the third processing layers, the evaluation unit is configured to evaluate the operation result of the first processing layer, the correction unit is configured to correct the first weight coefficient relating to the first processing layer based on the evaluation result of the evaluation unit, and the storage unit is configured to store the operation result of the first processing layer and the weight coefficient relating to the first processing layer.

18. The method according to claim 17, wherein
the first processing layer is configured to perform an arithmetic operation on the input data, the second processing layer is configured to perform an arithmetic operation on output data of the first processing layer, and the third processing layer is configured to perform an arithmetic operation on output data of the second processing layer, and
in a case where the weight coefficients relating to the first, the second, and the third processing layers are corrected, the first weight coefficient relating to the first processing layer, the second weight coefficient relating to the second processing layer, and the third weight coefficient relating to the third processing layer are corrected in order of appearance.

19. The method according to claim 17, wherein
in a case where the third weight coefficient relating to the third processing layer is corrected, an operation result of the second weight coefficient relating to the second processing layer before correction is used.

20. The method according to claim 17, wherein
in a case where the third weight coefficient relating to the third processing layer is corrected, an operation result of the second weight coefficient relating to the second processing layer after correction is used.
